(19) United States
(12) Patent Application Publication
(10) Pub. No.: US 2023/0098214 A1
(43) Pub. Date: Mar. 30, 2023

(54) Smartphone that Saves Encrypted Photos in External Storage Devices

(71) Applicants: Meir Dahan, Adi (IL); Eliahu Antopolsky, Zichron Yaakov (IL)

(72) Inventors: Meir Dahan, Adi (IL); Eliahu Antopolsky, Zichron Yaakov (IL)

(21) Appl. No.: 17/483,845

(22) Filed: Sep. 24, 2021

(51) Int. Cl. G06F 21/78; G06F 21/60; H04N 5/77; H04M 1/725

(52) U.S. Cl. CPC G06F 21/78; G06F 21/602; H04N 5/77; H04M 1/725

(57) ABSTRACT

A smartphone that is suitable to shoot or take a video or a photo and save them in an external storage device that can communicate with a connecting unit in the smartphone. The smartphone is capable of being operated in external save mode and to save the video or the photo solely in the external storage device. The smartphone may include an encryption subsystem to encrypt the video or the photo or a voice recordation, and a decryption subsystem. The encryption subsystem can encrypt the video or the photo or the voice recordation in such a way that they can be decrypted by using personal keys that were identified by a personal key identification reader of the smartphone before the camera shoots the video or takes the photo or before the microphone executes the voice recordation.

### FIELD OF THE INVENTION

The present invention relates to a smartphone that is designed to shoot videos and photos and to execute voice recordation that can be solely saved in encrypted form in external data storage devices.

### BACKGROUND OF THE INVENTION

In many cases a person may wish to use his smartphone to shoot a video, to take a photo or to execute a voice recordation but he prefer to save them in an external data storage device, such as a USB flash, and that they will not be save at all at any time in the memory means inside his smartphone, so that if his smartphone falls to the hands of the police, his wife, her husband, journalist or simple criminals then no one of them may find these videos, photos and voice recordation.

There are many stories that one can read in the news about people whose smartphones have fallen into the wrong hands, and as a result of photos, videos or voice recordings found in the smartphones that people have been severely entangled, hence it is clear that a smartphone that make it possible to shoot videos, take photos and to execute voice recordation and that these will not be saved at all in the smartphones. The present invention discloses good solutions to this issue.

In addition to that, in many cases disputes arise as to the nature and the content of meetings that were held in the past, mainly when such meetings were not recorded and were between two persons in private. Experience of life teaches us that in many such cases one participant alleges ex post facto that during the meeting certain events have happened or certain spoken words have been told and on the other hand the other participant alleged differently. Systems for meeting documentation which include audio and video recording are known in the art and can provide satisfactory solution in a wide range of cases. However, such a solution is not sufficient in special cases, when the participants have interest to record the meeting and in the same time they are also interested in the safety of documentation, in the meaning that no one - even one of the participant - would have an access to the documentation without specific consent of all the participant of that meeting.

Such kind of meetings can be for example: meetings between psychologist or psychiatric and patient in which the patient discloses private information that he does not want that this information would be disclosed to others; meetings between attorney and his client when they discuss sensitive matters; meetings for medical treatment such as dental, physiotherapy and other kinds of medical treatment; and also sexual meetings and the like. The expression “personal meeting” or “face to face personal meeting” in this paper relates to all of those kind of meetings, which express meetings in which the participants are together in the same physical location at the same time when they can directly see each other and hear each other without aids of any kind of external equipment beside their eyes and ears.

There are many sound and video recording devices that are not, however, equipped with any components that prevent unauthorized access to the documentation. The present invention offers a solution for people, mainly service providers, for example therapists, doctors, lawyers and the like who wish to record their personal meeting with their clients in a way that will prevent any access to the recording unless such access is authorized by all of the meeting's participants and by the positive action of each and every one of the participants. The present invention also discloses some additional embodiments.

### LIST OF DRAWINGS

The intention of the drawings attached to the application is not to limit the scope of the invention and its application. The drawings are intended only to illustrate the invention and they constitute only one of its many possible implementations.

FIG. 1 depicts schematically the smartphone (1) and its main components.

FIG. 2 depicts schematically the smartphone (1) with two connecting units.

### THE INVENTION

The main object of the present invention is to provide a smartphone (1) that is suitable to shoot videos, to take photos and save them in an external data storage device (100). The smartphone may has the necessary components as any standard smartphone such as a processor (10), a flash memory (11), a cellular modem (12), an RF transceiver (13), a touch screen (14), and a camera (15a) that is suitable to shoot the video or to take the photo and a microphone (15b). The smartphone further includes a connecting unit (20) that is designed to communicate electronically with the external data storage device (100).

The smartphone (1) is capable of being operated in external save mode, so that the smartphone when is in the external save mode is designed to save the video or the photo solely in the external data storage device (100) that communicates electronically with the connecting unit (20) while the camera shoots the video or takes the photo. The smartphone may have several options in its operation system in the settings of the smartphone itself or in the settings of the camera. So that the user can choose the saving option that he wants, such as, saving only in the smartphone itself, saving solely in the external data storage device (100) or saving the file (video, photo or the voice recordation) in both. The video or the photo may be displayed on the touch screen in real time.

This first embodiment of the present invention provides a great solution to the needs of many people that wish to shoot a video, to take a photo or to execute a voice recordation by their smartphones and to save them outside the smartphone and without leaving them or traces in their smartphone that can be reveal by other people.

When a person use his smartphone to take photos in external save mood he knows that the photos are saved only and solely in the external data storage device (100) that he can keep safe in his possession. This option can be used if the owner of the smartphone shots video of another person, so that that person can take the external data storage device with the saved video knowing that no traces left in the smartphone.

The connecting unit (20) can be for example a component such as Bus port in a type of USB port for example that are commonly used in our days in connection with electronic devices or a component that based on Bluetooth communication or Near-Field Communication and in such cases the external storage device will be accordingly. The connecting unit (20) is designed to be electronically communicated with the external data storage device (100) (in short “external storage device”) that can be for example a USB Flash drive in which it is possible to save the video and the photos files. It is possible that the smartphone (1) will have one or two or more connecting units (20) so that few persons can insert their external storage devices into the connecting units and to have in their possession (in their own USB Flash drive) the saved video or photos. It is possible to use an adapter with one leg that can be inserted into the connecting unit or communicated with the connecting unit and that adapter has several connecting units on it for multiple external storage devices.

The second embodiment of the invention refers to the smartphone (1) that is designed to shoot a video or to take a photo or to execute a voice recordation that is suitable to save the video, the photo or the voice recordation in encrypted form in the external data storage device. The smartphone also includes a personal key identification reader (16) that is designed to identify personal keys. The personal key identification reader (in short “reader”) is designed to identify personal keys, for example a biometric identification reader such as a fingerprint reader, a face recognition reader, a retina identification reader, an iris identification reader, or a voice recognition reader. In such cases, the personal keys can be a biometric feature, such as a face characteristic, voice, fingerprint, retina and other kind of features. The reader may be based on typing a code or magnetic cards and the like.

The smartphone includes also the connecting unit that is designed to communicate electronically with the external data storage device, an encryption subsystem (30) that when is activated is designed to encrypt the video or the photo or the voice recordation, and a decryption subsystem (40).

The smartphone is capable of being operated in the external save mode, so that the smartphone when is in external save mode is designed to save the video or the photo or the voice recordation or the encrypted video or the encrypted photo or the encrypted voice recordation solely in the external data storage device that communicates electronically with the connecting unit while the camera shoots the video or takes the photo or while the microphone executes the voice recordation.

The encryption subsystem is designed to encrypt the video or the photo or the voice recordation in such a way that the encrypted video or the encrypted photo or the encrypted voice recordation is designed to be decrypted by the decryption subsystem by using one or more personal keys of one or more persons that were identified by the personal key identification reader before the camera shoots the video or takes the photo or before the microphone executes the voice recordation or by using a unique identifier of the smartphone.

When the encrypted video or the encrypted photo or the encrypted voice recordation is saved in the external data storage device then it is saved with information as to said identified personal keys or with information as to the unique identifier of the smartphone and the decryption subsystem is designed to decrypt the encrypted video or the encrypted photo or the encrypted voice recordation when an external data storage device in which the encrypted video or the encrypted photo or the encrypted voice recordation is saved communicates electronically with the connecting unit, and when the personal key identification reader identifies the identified personal keys or when the smartphone includes the unique identifier.

It should be noted that there is no necessity that all of the participants of a meeting that is documented by the video or the voice recordation or of the photo (the persons that appear in the photo) will insert their personal keys into the smartphone. It can be a case when there are five participants of the meeting but it is enough to the opinion on those five persons that only two participants will be the guards and controllers of the encrypted video and only these two participants may insert their personal keys, and it is possible that a person that is not a participant of that event that is documented by the video will insert his personal key and become a guardian. It is also possible that only one person will insert his personal key. For example, in a massage therapy it seems enough that the client will insert his personal key and the SPA will keep an encrypted voice recordation so that the client will feel safe and comfort and in any future allegation they SPA can bring the USB and the client will give his fingerprint for opening the encrypted voice recordation and the judge can hear the voice recording and to come to conclusion what happened during that session. The term participant refers therefore to the persons who inserted their personal keys for that shooting, taking photos or executing the voice recordation.

The participants of a personal meeting aware of the fact that the video or the photos or the voice recordation cannot be saved inside the smartphone (1) when it is in the external save mode but only in the external storage device (their USB flash device), and this fact is likely to make them feel more comfortable as to the safety and privacy of the videos, photos and voice recordation. The encrypted video is saved in the external data storage devices with information as to the identified personal keys of the participants, means the participants or the person or persons who inserted their personal keys into the device before the shooting the video or before executing the voice recordation. This fact makes it clear to the participants that the saved video and voice recordation is encrypted and cannot be viewed without their future consent.

It is possible that before shooting the video or executing the voice recordation the participants (or one of them or few of them) insert their personal keys (fingerprint for example) to the personal key identification reader (16) and then they may activate the smartphone and the camera that shoots the video in external save mode and in encrypted form. The streaming video is encrypted and saved in the external USB flash drivers that are connected at that time with the connecting unit of the smartphone.

The term “encrypted” in this paper and in the claims means that the video or the photos or the voice recordation is encrypted or scrambled or undergoing a process that disable it from being opened and viewed, but only by using the personal keys that were inserted before shooting the video or executing the voice recordation. The term “decrypted” in this paper and in the claims means that the video or the voice recordation can be opened and viewed and also with a possible option to enable the participants to cancel the encryption permanently.

The encrypted video or the encrypted voice recordation is saved in the external storage device and the decryption of this saved video can be done only by using the personal keys of the participants of that face to face personal meeting as inserted prior the shooting of that video or executing that voice recordation.

It is clear from the above explanation that decryption and access to the saved encrypted video can be done only by consent of the participants of that face to face personal meeting, by using all of their personal keys. Each participant of that specific face to face personal meeting is aware of the fact that the saved video is locked and inaccessible to any person without using his personal key.

People can document their face to face personal meeting using their biometric features as personal keys and if after that meeting one of the participants alleged that during the meeting something wrong had happened, or in any other case of disagreeing as to the nature of the meeting, the participants can together view the video, in a presence of a Judge, and by that to resolve the dispute. The smartphone (1) with the features of external save mode and also when in encryption form mode can be used also by a person who wants to take videos, photos and voice recordation and save them on his USB or another external storage device without leaving traces in his smartphone.

The smartphone (1) also include its inner chargeable battery, its operation system that can be featured on the touch screen or buttons that enable the user to activate the camera and the microphone, to insert the personal keys, to give a command to view or decrypt the video on the screen and the like.

The third embodiment of the present invention refers to the smartphone (1) that is designed to shoot the video or to take the photo or to execute the voice recordation and that is suitable to save them in encrypted form in a first external data storage device (100a ) and in a second external data storage device (100b ). In this embodiment the smartphone (1) includes a first connecting unit (20a ) that is designed to communicate electronically with the first external data storage device and a second connecting unit (20b ) that is designed to communicate electronically with the second external data storage device.

The smartphone is capable of being operated in double external save mode, so that the smartphone when is in double external save mode is designed to save the video or the photo or the voice recordation or the encrypted video or the encrypted photo or the encrypted voice recordation solely in the first and in the second external data storage devices that communicate electronically with the first and the second connecting units while the camera shoots the video or takes the photo or while the microphone executes the voice recordation.

In this embodiment the smartphone is designed to save the encrypted video or the encrypted photo or the encrypted voice recordation in the first external data storage device that communicates electronically with the first connecting unit with a first part code information and in the second external data storage device that communicates electronically with the second connecting unit with a second part code information.

The encrypted video or the encrypted photo or the encrypted voice recordation is configured to be decrypted by the decryption subsystem when an external data storage device in which the encrypted video or the encrypted photo or the encrypted voice recordation is saved with the first part code information and an external data storage device in which the encrypted video or the encrypted photo or the encrypted voice recordation is saved with the second part code information communicate electronically with the first and the second connecting units.

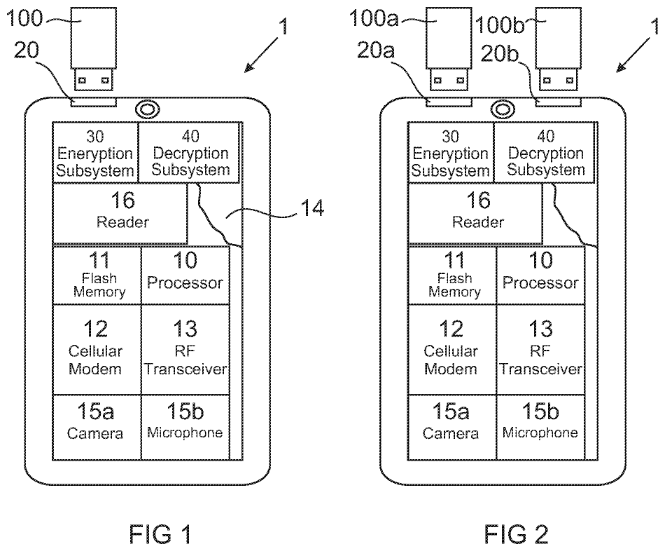

FIG. 1 depicts schematically the smartphone (1) and its main components, and

FIG. 2 depicts schematically the smartphone (1) with two connecting units.

What is claimed is:

1. A smartphone that is suitable to shoot a video and to take a photo and save them in an external data storage device, comprising: a processor, a flash memory, a cellular modem, an RF transceiver, a touch screen, and a camera that is suitable to shoot the video or to take the photo;
wherein the smartphone further comprises a connecting unit that is designed to communicate electronically with the external data storage device;
wherein the smartphone is capable of being operated in external save mode, so that the smartphone when is in external save mode is designed to save the video or the photo solely in the external data storage device that communicates electronically with the connecting unit while the camera shoots the video or takes the photo.

2. A smartphone that is designed to shoot a video or to take a photo or to execute a voice recordation that is suitable to save the video, the photo or the voice recordation in encrypted form in an external data storage device, comprising: a processor, a flash memory, a cellular modem, an RF transceiver, a touch screen, a personal key identification reader that is designed to identify personal keys, a camera and a microphone;
wherein the smartphone further comprises a connecting unit that is designed to communicate electronically with the external data storage device, an encryption subsystem that when is activated is designed to encrypt the video or the photo or the voice recordation, and a decryption subsystem;
wherein the smartphone is capable of being operated in external save mode, so that the smartphone when is in external save mode is designed to save the video or the photo or the voice recordation or the encrypted video or the encrypted photo or the encrypted voice recordation solely in the external data storage device that communicates electronically with the connecting unit while the camera shoots the video or takes the photo or while the microphone executes the voice recordation;
wherein the encryption subsystem is designed to encrypt the video or the photo or the voice recordation in such a way that the encrypted video or the encrypted photo or the encrypted voice recordation is designed to be decrypted by the decryption subsystem by using one or more personal keys of one or more persons that were identified by the personal key identification reader before the camera shoots the video or takes the photo or before the microphone executes the voice recordation or by using a unique identifier of the smartphone;
wherein when the encrypted video or the encrypted photo or the encrypted voice recordation is saved in the external data storage device then it is saved with information as to said identified personal keys or with information as to the unique identifier of the smartphone; and
wherein the decryption subsystem is designed to decrypt the encrypted video or the encrypted photo or the encrypted voice recordation when an external data storage device in which the encrypted video or the encrypted photo or the encrypted voice recordation is saved communicates electronically with the connecting unit, and when the personal key identification reader identifies the identified personal keys or when the smartphone includes the unique identifier.

3. A smartphone that is designed to shoot a video or to take a photo or to execute a voice recordation that is suitable to save the video, the photo or the voice recordation in encrypted form in a first external data storage device and in a second external data storage device, comprising: a processor, a flash memory, a cellular modem, an RF transceiver, a touch screen, a personal key identification reader that is designed to identify personal keys, a camera and a microphone;
wherein the smartphone further comprises a first connecting unit that is designed to communicate electronically with the first external data storage device and a second connecting unit that is designed to communicate electronically with the second external data storage device, an encryption subsystem that when is activated is designed to encrypt the video or the photo or the voice recordation, and a decryption subsystem;
wherein the smartphone is capable of being operated in double external save mode, so that the smartphone when is in double external save mode is designed to save the video or the photo or the voice recordation or the encrypted video or the encrypted photo or the encrypted voice recordation solely in the first and in the second external data storage devices that communicate electronically with the first and the second connecting units while the camera shoots the video or takes the photo or while the microphone executes the voice recordation;
wherein the device is designed to save the encrypted video or the encrypted photo or the encrypted voice recordation in the first external data storage device that communicates electronically with the first connecting unit with a first part code information and in the second external data storage device that communicates electronically with the second connecting unit with a second part code information;
wherein the encrypted video or the encrypted photo or the encrypted voice recordation is configured to be decrypted by the decryption subsystem when an external data storage device in which the encrypted video or the encrypted photo or the encrypted voice recordation is saved with the first part code information and an external data storage device in which the encrypted video or the encrypted photo or the encrypted voice recordation is saved with the second part code information communicate electronically with the first and the second connecting units.
